(19) United States
(12) Patent Application Publication
(10) Pub. No.: US 2017/0165845 A1
(43) Pub. Date: Jun. 15, 2017

(54) ROBOT, CONTROL METHOD FOR ROBOT, AND PROGRAM

(71) Applicant: SHARP KABUSHIKI KAISHA, Sakai City, Osaka (JP)

(72) Inventor: Yusuke KURIMOTO, Sakai City (JP)

(21) Appl. No.: 15/124,737

(22) PCT Filed: Nov. 18, 2015
(86) PCT No.: PCT/JP2015/082385

§ 371 Date: Sep. 9, 2016

(30) Foreign Application Priority Data
Oct. 28, 2014 (JP) 2014-219615

(51) Int. Cl. B25J 13/08; B25J 9/16

(52) U.S. Cl. CPC B25J 13/081; B25J 9/1694; G05B 2219/40581; G05B 2219/40201

(57) ABSTRACT

While a location where a user is touching a robot (1) is being detected, a movement control section (14) controls a plurality of movable members such that (i) out of the plurality of movable members, a movable member corresponding to the location is prohibited from moving and (ii) every other movable member of the plurality of movable members is permitted to move. This makes it possible to provide a robot (1) that enables injury-free use by a user while the user is touching the robot (1).

### TECHNICAL FIELD

The present invention relates to (i) a robot having a plurality of differing movable members, (ii) a method of controlling a robot, and (iii) a program.

### BACKGROUND ART

In recent years, advances in robot technology have enabled the creation of robots that can converse with or otherwise communicate with a user. In particular, advances in robot miniaturization have enabled the creation of robots which a user can easily pick up, carry, and use outdoors. However, such a robot exhibits a problem that in a case where a user touches or picks up the robot, the user's hand may get caught in a moving part of the robot and be injured.

Technology intended to address such a problem is disclosed in Patent Literature 1. Patent Literature 1 discloses a robot provided with a pressure sensor on a gripping part of a gripper. When the robot detects an operator gripping the gripping part, the robot deactivates all joint actuators in response to the detection. Patent Literature 1 discloses that a benefit of such a robot resides in that an operator carrying the robot will not be injured even in a case where the robot suddenly goes out of control.

### CITATION LIST

### Patent Literature

### [Patent Literature 1]

Japanese Patent Application Publication, Tokukai No. 2009-18418, (Publication date: Jan. 29, 2009)

### [Patent Literature 2]

PCT International Publication No. 00/32360 (Publication date: Jun. 8, 2000)

### [Patent Literature 3]

Japanese Patent Application Publication, Tokukai No. 2004-306251 (Publication date: Nov. 4, 2004)

### [Patent Literature 4]

Japanese Patent Application Publication, Tokukai No. 2004-174644 (Publication date: Jun. 24, 2004)

### SUMMARY OF INVENTION

### Technical Problem

The robot of Patent literature 1 exhibits the problem that while the operator of the robot is touching the robot, the operator will not be injured, but, as a tradeoff, the robot cannot be used.

The present invention was made in view of the above problem. An object of the present invention lies in providing (i) a robot, (ii) a method of controlling a robot, and (iii) a program, each of which enables injury-free use of the robot by the user while the user is touching the robot.

### Solution to Problem

In order to solve the above problem, a robot in accordance with the present invention includes: a plurality of movable members; a detecting section configured to detect a location where the robot is being touched; and a control section configured to control the plurality of movable members such that, while the location is being detected, (i) out of the plurality of movable members, a movable member corresponding to the location is prohibited from moving and (ii) every other movable member of the plurality of movable members is permitted to move.

### Advantageous Effects of Invention

One aspect of the present invention brings about an advantageous effect of enabling injury-free use of the robot by the user while the user is touching the robot.

### BRIEF DESCRIPTION OF DRAWINGS

FIG. 1 is a block diagram showing a configuration of main components of a robot in accordance with Embodiment 1 of the present invention.

FIG. 2 is a table showing correspondence between (i) a location where the user is touching on the robot and (ii) a movable part subject to being moved, the table being provided in advance in the robot in accordance with Embodiment 1 of the present invention.

FIG. 3 illustrates an example of (i) which movable members move and (ii) which movable members stop, while the user touches the robot in accordance with Embodiment 1 of the present invention.

FIG. 4 illustrates another example of (i) which movable members move and (ii) which movable members stop, while the user touches the robot in accordance with Embodiment 1 of the present invention.

FIG. 5 is a diagram illustrating an example of how the robot in accordance with Embodiment 1 of the present invention moves, both before and after receiving a movement commencement instruction.

FIG. 6 is a diagram illustrating another example of how the robot in accordance with Embodiment 1 of the present invention moves, both before and after receiving movement commencement instructions.

FIG. 7 is a flowchart showing how processing is performed in a case where the robot in accordance with Embodiment 1 of the present invention is in a non-moving state and is to commence movement.

FIG. 8 is a diagram illustrating how a robot, in accordance with Embodiment 2 or the present invention, moves both before and after a user touches the robot, which is initially in a state of moving.

FIG. 9 is a flowchart showing how processing is performed during movement of the robot in accordance with Embodiment 2 of the present invention.

FIG. 10 is a diagram illustrating how a robot, in accordance with Embodiment 3 of the present invention, moves both before and after a user stops touching the robot while the robot is in a state of moving.

FIG. 11 is a flowchart showing how processing is performed during movement of the robot in accordance with Embodiment 3 of the present invention.

### DESCRIPTION OF EMBODIMENTS

### Embodiment 1

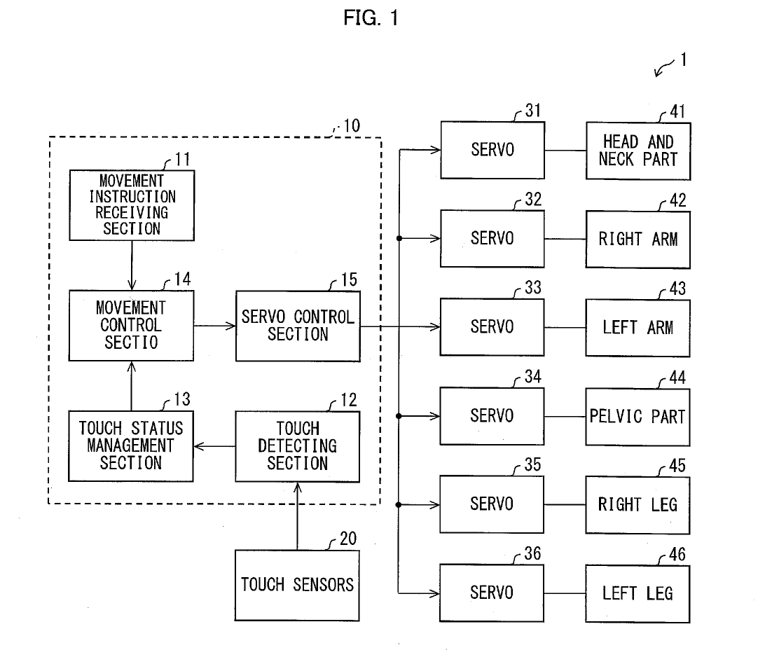

The following description will discuss Embodiment 1 of the present invention with reference to FIGS. 1 through 5.

FIG. 1 is a block diagram showing a configuration of main components of a robot 1. As shown in FIG. 1, the robot 1 includes a control section 10, touch sensors 20, six servos 31-36, and six movable members (a head and neck part 41, a right arm 42, a left arm 43, a pelvic part 44, a right leg 45, and a left leg 46). The control section 10 includes a movement instruction receiving section 11 (receiving section), a touch detecting section 12 (detecting section), a touch status management section 13, a movement control section 14 (control section), and a servo control section 15 (control section).

The robot 1 has a human-like appearance and has six movable members corresponding to six main parts of the human body. Servos allow the respective movable members to move independently. Servos 31-36 each automatically operate so as to cause controlled variables, such as a position, a direction, and posture of a corresponding movable member to reach a corresponding target value. In Embodiment 1, the servo 31, the servo 32, the servo 33, the servo 34, the servo 35, and the servo 36 are provided for the head and neck part 41, the right arm 42, the left arm 43, the pelvic part 44, the right leg 45, and the left leg 46, respectively. Correspondence between the servos and the movable members is not limited to being a 1-to-1 relation. For example, the robot 1 can alternatively include a plurality of servos that collectively control a single movable member.

The touch sensors 20 are realized by, for example, pressure sensors or touch sensitive panels provided on the entire body of the robot 1. The touch sensors 20 each supply, to the touch detecting section 12, a predetermined signal corresponding to a user touching location on the robot 1. The touch detecting section 12 detects the user touching location on the robot 1 in accordance with a received signal. The robot 1 is provided, in advance, with a table indicating correspondence between a specific signal and a touching location. The touch detecting section 12 utilizes this table to identify the user touching location.

The robot 1 detects a location where the user is touching the robot 1. While the location is being detected, (i) each of the plurality of movable members that corresponds to a detected location is prohibited from moving and (ii) each of the plurality of movable members other than those corresponding to the detected location is permitted to move. This enables injury-free use of the robot 1 by the user while the user is touching the robot 1.

The touch detecting section 12 supplies, to the touch status management section 13, a detected result as to the location where the user is touching. The touch status management section 13 manages, in the predetermined table (touch status management table), information indicative of what locations of the robot 1 the user is and is not touching. In the table, touch-detectable locations of the robot 1 are associated with information indicating which touch-detectable location(s) the user is touching.

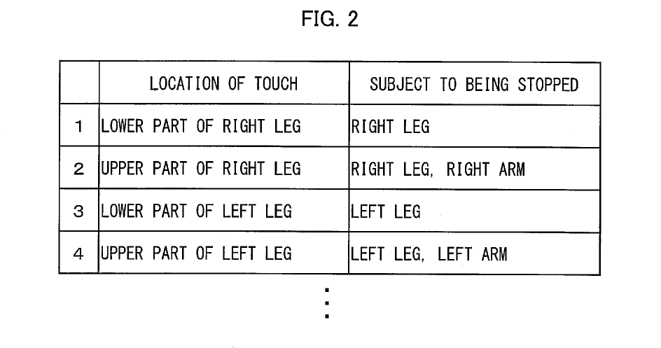

The movement control section 14 obtains, from the touch status management section 13, a touch status management table updated with the most recent status. The movement control section 14 identifies a location where the user is touching the robot 1 by referring to such a table. The movement control section 14 then identifies which movable member corresponds to an identified location where the user is touching, by referring to the table shown in FIG. 2. FIG. 2 is a table that (i) is provided in advance in the robot 1 and (ii) shows correspondence between (a) a location where the user is touching on the robot 1 and (b) a movable part subject to being stopped. The movement control section 14 refers to the table shown in FIG. 2 to identify a movable member(s) corresponding to at least one identified location where the user is touching. By doing so, the movement control section 14 determines which of the movable members is subject to being stopped. The movement control section 14 determines moveable members other than those subject to being stopped as subject to being moved.

In a case where there are a plurality of detected locations where the user is touching, the movement control section 14 determines which of the movable members is subject to being stopped by taking the logical sum of movable members corresponding to respective detected locations, in the table, where the user is touching. For example, assume a case where the touch detecting section 12 detects the user touching (i) a lower part of the left leg 46 and (ii) an upper part of the right leg 45. In such a case, the movement control section 14 takes the logical sum of (i) the movable members subject to stopping as specified in item No. 2 of the table of FIG. 2 (the right leg 45 and the right arm 42) and (ii) the movable member subject to stopping as specified in item No. 3 of the same table (the left leg 46). By thus taking the logical sum of these specified members, the movement control section 14 determines that the movable members subject to being stopped are the right arm 42, the right leg 45, and the left leg 46.

Note that the robot 1 can be provided in advance with a table indicating correspondence between (i) a location where the user can touch on the robot 1 and (ii) a movable member subject to being moved. In such a case, the movement control section 14 refers to the table to identify a movable member(s) corresponding to at least one identified location where the user is touching touch. The movement control section 14 then notifies the servo control section 15 of movement being (i) permitted for an identified movable member thus identified and (ii) prohibited for each of the other movable members.

The movement control section 14 notifies the servo control section 15 of movement being (i) prohibited for a movable member subject to being stopped and (ii) permitted for a movable member subject to being moved. The servo control section 15 controls how the servos 31-36 should operate, in accordance with the notification. For example, in a case where (i) a servo is moving and (ii) that servo corresponds to a movable member whose movement is prohibited, the servo control section 15 controls that servo to stop moving. Conversely, in a case where (i) a servo is operating and (ii) that servo corresponds to a movable member whose movement is permitted, the servo control section 15 controls that servo to start moving or resume moving.

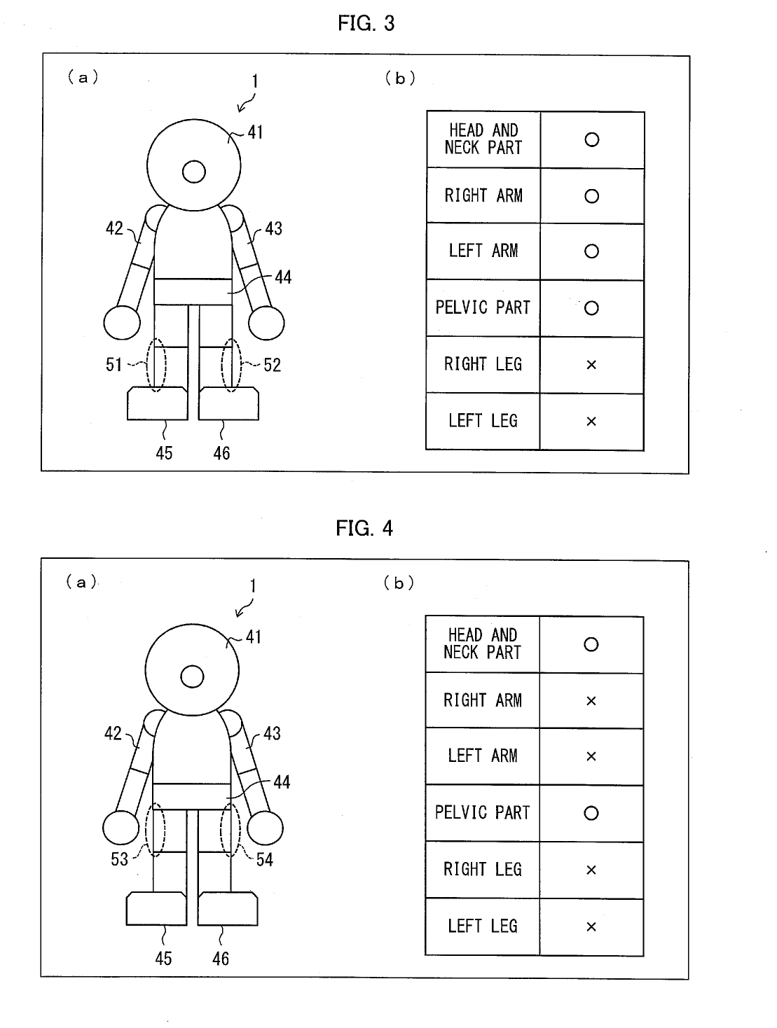

FIG. 3 illustrates an example of (i) which movable members move and (ii) which movable members stop, while the robot 1 is being touched. In the example illustrated in (a) of FIG. 3, the user is touching locations 51 and 52 on the robot 1. The location 51 corresponds to the lower part of the right leg 45, and the location 52 corresponds to the lower part of the left leg 46. In the table shown in FIG. 2, movable members, corresponding to at least one of (i) the upper part of the right leg 45 and (ii) the lower part of the left leg 46, are the right leg 45 and the left leg 46. Thus, as shown in (b) of FIG. 3, movement is prohibited (denoted by an “x” in FIG. 3) for the right leg 45 and left leg 46, whereas movement is permitted (denoted by a circle in FIG. 3) for the head and neck part 41, the right arm 42, the left arm 43, and the pelvic part 44.

With the configuration, in a case where the user touches locations 51 and 52 when the entire body of the robot 1 is moving, the right leg 45 and the left leg 46, which are near locations 51 and 52, respectively, are stopped. However, the head and neck part 41, the right arm 42, the left arm 43, and the pelvic part 44, which are not near locations 51 and 52, continue to move. This prevents user injury that could otherwise be caused by the user's hand being hit or pinched by the right leg 45 or the left leg 46 while the user is touching the robot 1. At the same time, other movable members, such as the head and neck part 41, continue to move, thereby allowing the user to continue using the robot 1.

FIG. 4 illustrates another example of (i) which movable members move and (ii) which movable members stop while the user touches the robot 1. In the example illustrated in (a) of FIG. 4, the user is touching locations 53 and 54 on the robot 1. Location 53 corresponds to the upper part of the right leg 45, and location 54 corresponds to the upper part of the left leg 46. In the table shown in FIG. 2, members corresponding to at least one of (i) the upper part of the right leg 45 and (ii) the upper part of the left leg 46 are (i) the right arm 42, (ii) the left arm 43, (iii) the right leg 45, and (iv) the left leg 46. Thus, as shown in (b) of FIG. 4, movement is prohibited (denoted by an “x” in FIG. 4) for the right arm 42, the left arm 43, the right leg 45, and the left leg 46, whereas movement is permitted (denoted by a circle in FIG. 4) for the head and neck part 41 and the pelvic part 44.

With the configuration, therefore, in a case where the user touches locations 53 and 54 while the entire body of the robot 1 is moving, movable members at locations 53 and 54 (the right leg 45 and the left leg 46) stop moving. Movement is also stopped for each movable member (the right arm 42 and the left arm 43) which could, during movement, potentially reach the user's hand while the user's hand is in contact with locations 53 and 54. However, the other movable members (the head and neck part 41 and the pelvic part 44) continue to move. The configuration therefore prevents user injury that could otherwise be caused by the user's hand being hit or pinched by the right arm 42, the left arm 43, the right leg 45, or the left leg 46 while the user is touching the robot 1. At the same time, other movable members such as the head and neck part 41 continue to move, thereby allowing the user to continue using the robot 1.

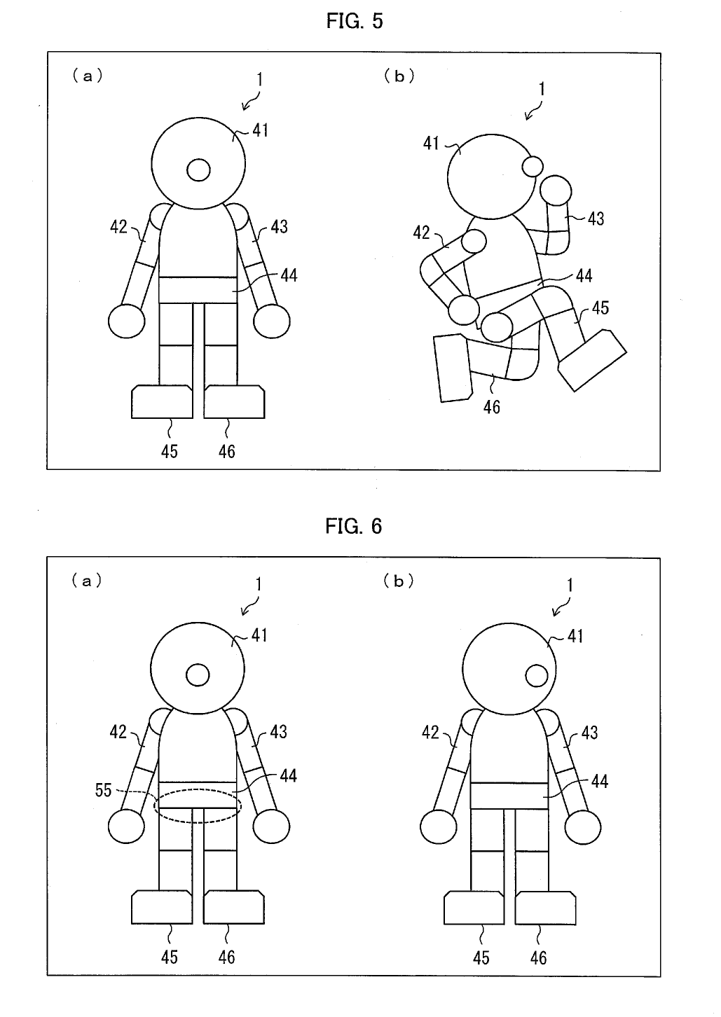

FIG. 5 illustrates an example of how the robot 1 moves both before and after receiving a movement commencement instruction. Assume a case where the robot 1 receives the movement commencement instruction when the robot 1 is completely stopped and the user is not touching the robot 1 at all (see (a) of FIG. 5). In such a case, there are no movable members determined as being subject to being stopped. As such, the robot 1 begins movement as normal, so that the entire body (all movable members) of the robot 1 move (see (b) of FIG. 5).

FIG. 6 is a diagram illustrating another example of how the robot 1 moves both before and after receiving a movement commencement instruction. Assume a case where the robot 1 receives the movement commencement instruction when (i) the robot 1 is completely stopped (see (a) of FIG. 6) and (ii) the user is touching an area of the robot 1 indicated by the dotted line 55. As shown in (b) of FIG. 5, after commencement of movement, the robot 1 maintains the non-moving state of the five movable members corresponding to the location where the user is touching in the area indicated by the dotted line 55 (the right arm 42, the left arm 43, the pelvic part 44, the right leg 45, and the left leg 46). Movement is commenced only for the one remaining movable member (the head and neck part 41).

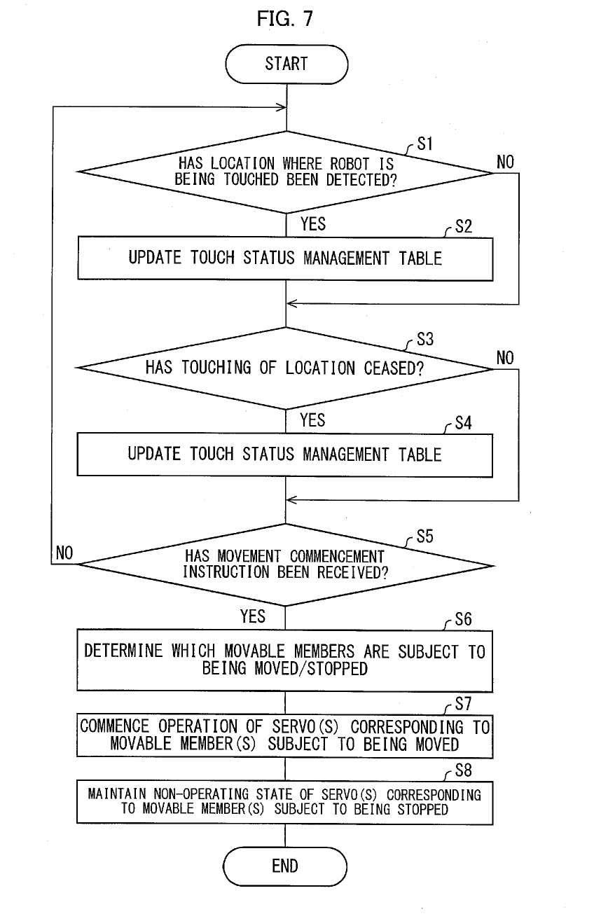

FIG. 7 is a flowchart showing how processing is performed in a case where the robot 1, in a non-moving state, is to commence movement. While the robot 1 is completely stopped, the touch detecting section 12 periodically determines whether or not a location where a user is touching on the robot 1 is being detected (S1). In a case where the touch detecting section 12 begins newly receiving, from at least one of the touch sensors 20, a signal corresponding to a location where the user is touching, the touch detecting section 12 determines that such a location has been detected. In the case of a “YES” result in S1, the touch detecting section 12 notifies the touch status management section 13 of such a location having been detected. Upon receipt of the notification, the touch status management section 13 updates the touch status management table (S2). In the case of a “NO” result in S1, however, step S3 is proceeded with.

After S1 or S2, the touch detecting section 12 determines whether or not the user has ceased touching the location of touch being detected (S3). In a case where the touch detecting section 12 no longer receives, from the touch sensors 20, a signal corresponding to a location where the user is touching, the touch detecting section 12 determines that the user has ceased to touch such a location where the user is touching. In the case of a “YES” result in S3, the touch detecting section 12 notifies the touch status management section 13 of such a location which is determined as being no longer touched. Upon receipt of the notification, the touch status management section 13 updates the touch status management table (S4). In the case of a “NO” result in S3, however, step S5 is proceeded with.

After S3 or S4, the movement instruction receiving section 11 determines whether or not a movement commencement instruction has been received (S5). In the case of a “NO” result in S5, the processing returns to S1. That is, S1 through S4 of the processing are repeated until S5 results in a “YES” result. Thus, while the robot 1 is completely stopped, the robot 1 is constantly updated with the most recent status of the user touching the robot 1.

In the case of a “YES” result in S5, the movement instruction receiving section 11 notifies the movement control section 14 of the “YES” result. The movement control section 14 obtains the most recent touch status management table from the touch status management section 13. The movement control section 14 then refers to the table to identify a current location where the user is touching on the robot 1. Subsequently, the movement control section 14 determines that (i) a movable member corresponding to such an identified location is subject to being stopped and (ii) all other movable members are subject to being moved (S6). In accordance with the determination, the movement control section 14 notifies the servo control section 15 of whether or not movement is permitted for each movable member. Upon receipt of the notification, the servo control section 15 commences operation of a servo corresponding to a movable member subject to being moved (S7) and also maintains the non-operating state of a servo corresponding to a movable member subject to being stopped.

As is clear from the above, according to Embodiment 1, in a case where the robot 1 receives a movement commencement instruction while the user is touching the robot 1 and the robot 1 is not moving, the robot 1 will not commence any movement of a movable member being touched by the user, nor any movement of movable members in the vicinity thereof. This prevents the user from being injured by sudden commencement of movement of any movable member.

Note also that, although the conventional art disclosed in Patent Literature 1 requires the addition of a dedicated member (handle) for stopping movement of a robot, such a dedicated member is not necessary with the robot 1. Furthermore, with the conventional art disclosed in Patent Literature 1, a user may (i) be hesitant to touch parts of the robot other than the handle, (ii) feel afraid to touch such parts, and/or (iii) feel that doing so would be dangerous. Such a problem does not occur with the robot 1, however, since user injury is prevented regardless of the location where the user is touching.

### Embodiment 2

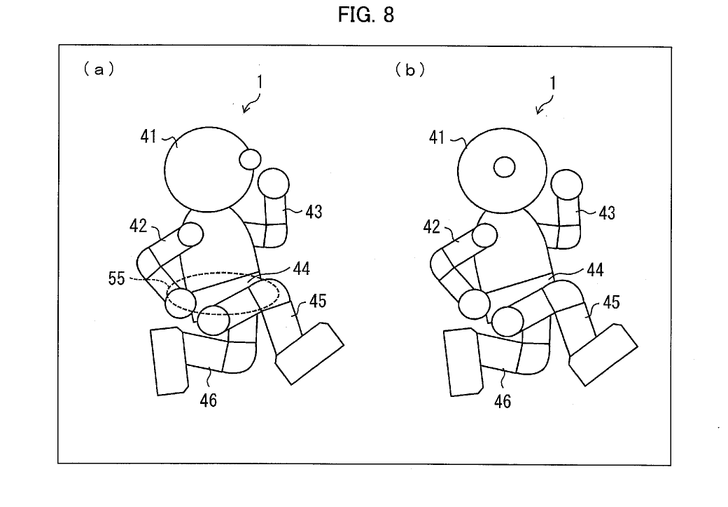

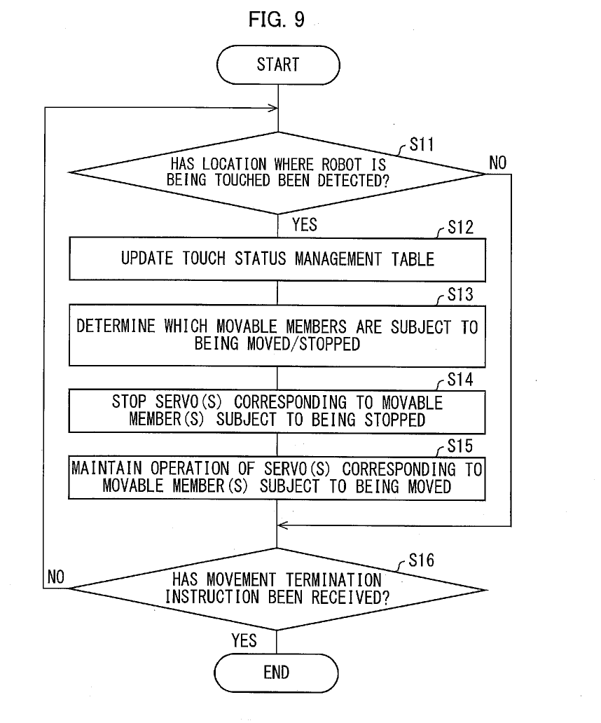

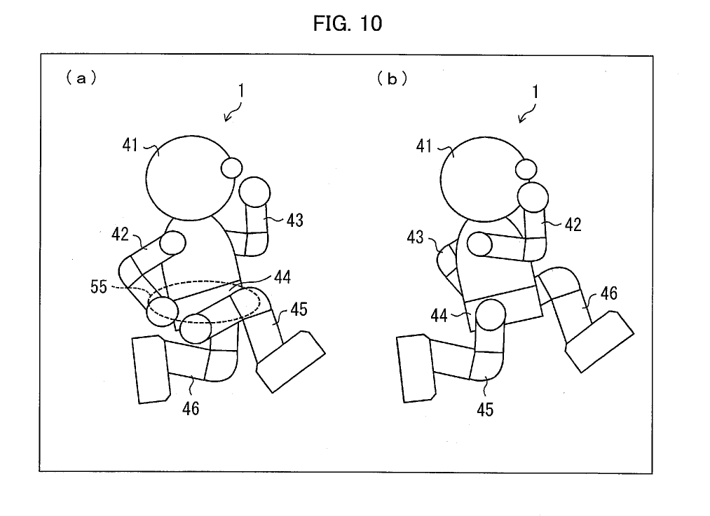

The following description will discuss Embodiment 2 in accordance with the present invention with reference to FIG. 8 and FIG. 9.

FIG. 8 is a diagram illustrating how a robot 1 moves both before and after a user touches the robot 1 which is initially in a state of moving. Assume a case where, as illustrated in (a) of FIG. 8, the robot 1, which is initially in a state of moving while not being touched, is touched by the user in an area indicated by the dotted line 55. In such a case, the robot 1 stops movements of respective five movable members (a right arm 42, a left arm 43, a pelvic part 44, a right leg 45, and a left leg 46) corresponding to the location where the user is touching in the area indicated by the dotted line 55 (see (b) of FIG. 6). At the same time, the robot 1 continues movement of the one remaining movable member (a head and neck part 41). That is, the robot 1 does not stop moving completely.

FIG. 9 is a flowchart showing how processing is performed during movement of the robot 1. While the robot 1 is moving, a touch detecting section 12 periodically determines whether a location where the user is touching on the robot 1 is being detected (S11). In a case where the touch detecting section 12 begins newly receiving, from at least one touch sensor 20, a signal corresponding to a location where the user is touching, the touch detecting section 12 determines that such a location has been detected. In the case of a “YES” result in S11, the touch detecting section 12 notifies a touch status management section 13 of a detected location. Upon receipt of the notification, the touch status management section 13 updates a touch status management table (S12). In the case of a “NO” result in S11, however, step S16 is proceeded with.

After S2, a movement control section 14 acquires the most recent touch status management table from the touch status management section 13. The movement control section 14 identifies current locations where the user is touching on the robot 1, by referring to this table. Subsequently, the movement control section 14 determines that (i) a movable member corresponding to an identified current location is subject to being stopped and (ii) all other movable members are subject to being moved (S13). In accordance with the determinations, the movement control section 14 notifies a servo control section 15 of whether or not movement is permitted for each movable member. Upon receipt of the notification, the servo control section 15 stops operation of a servo corresponding to a movable member subject to being stopped (S14), while also continuing operation of a servo corresponding to a movable member subject to being moved (S15). As a result, a movable member subject to being stopped is stopped, but all other movable members continue to move.

After S15, the movement instruction receiving section determines whether or not a movement termination instruction has been received (S16). In the case of a “NO” result in S16, the processing returns to S11. That is, as long as S16 does not result in a “YES” result, the robot 1 continues moving by repeating steps S11 through S15. However, in the case of a “NO” result in S16, the processing ends. This completely stops movement of the robot 1 regardless of whether or not the user is touching the robot 1.

As is clear from the above, according to Embodiment 2, in a case where the user touches the robot 1 while any of a plurality of movable members is moving, a movable member corresponding to a detected location where the user is touching is stopped, but all other movable members that are moving continue to move. This configuration allows the user to continue injury-free use of the robot 1 even in a case where the user is touching the robot 1 while the robot 1 is moving.

### Embodiment 3

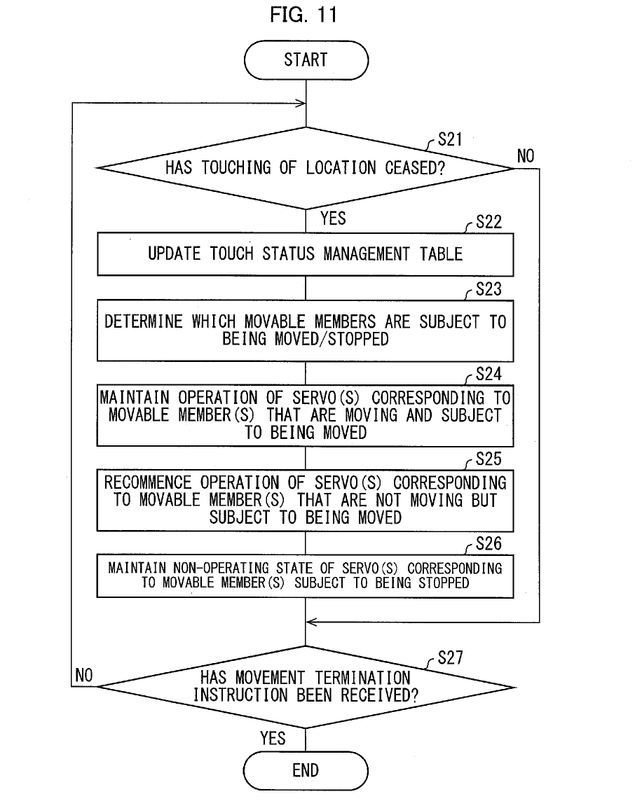

The following description will discuss Embodiment 2 in accordance with the present invention with reference to FIGS. 10 and 11.

FIG. 10 is a diagram illustrating how a robot 1 moves both before and after a user stops touching the robot 1 while the robot 1 is in a state of moving. As shown in (a) of FIG. 10, the user is touching the robot 1 in an area indicated by the dotted line 55 while the robot 1 is moving. Because of this, the robot 1 moves only a head and neck part 41 and keeps the remaining five movable members in a non-moving state. Note, here, that if the user ceases touching the robot 1, the robot 1 will recommence movement of the five stopped movable members, as illustrated in (b) of FIG. 10. By causing all movable members to move, the robot 1 returns to the state of movement it was in before being touched by the user.

FIG. 11 is a flowchart showing how processing is performed during movement of the robot 1. While the robot 1 is moving, a touch detecting section 12 determines whether or not the user has ceased touching a detected location of touch (S21). In a case where the touch detecting section 12 has stopped receiving, from a touch sensor 20, a signal corresponding to a location where the user is touching, the touch detecting section 12 determines that the user has ceased touching such a location. In the case of a “YES” result in S21, the touch detecting section 12 notifies a touch status management section 13 of a location determined as being no longer touched. Upon receipt of the notification, the touch status management section 13 updates a touch status management table (S22). In the case of a “NO” result in S21, however, S27 is proceeded with.

After S22, a movement control section 14 acquires the most recent touch status management table from the touch status management section 13. The movement control section 14 identifies current locations where the user is touching on the robot 1, by referring to this table. Subsequently, the movement control section 14 determines that (i) a movable member corresponding to an identified current location is subject to being stopped, and (ii) all other movable members are subject to being moved (S23). In accordance with the determinations, the movement control section 14 notifies a servo control section 15 of whether or not movement is permitted for each movable member.

Upon receipt of the notification, the servo control section 15 continues operation of a servo corresponding to a movable member that is both moving and subject to being moved (S24). The servo control section 15 also recommences operation of a servo corresponding to a movable member that is not moving but is subject to being moved (S25). The servo control section 15 also maintains a non-operating state of a servo subject to being stopped (S26). As a result, movement is commenced for a movable member corresponding to a location where the user was touching which location is no longer being touched, and, concurrently, the current state of movement commencement or non-moving state of all other movable members is maintained. That is, the robot 1 increases the number of movable members to be moved.

After S27, the movement instruction receiving section 11 determines whether or not a movement termination instruction has been received. In the case of a “NO” result in S27, the processing returns to S21. That is, as long as S27 does not result in a “YES” result, the robot 1 continues movement by repeating steps S21 through S26 of the processing. In the case of a “NO” result in S27, however, the processing ends. This completely stops movement of the robot 1 regardless of whether or not the user is touching the robot 1.

As is clear from above, according to Embodiment 3, in a case where the user ceases to touch the robot 1, the robot 1 can return to the state of normal movement it was in before being touched by the user. That is, the robot 1 will not needlessly maintain a non-moving state of a movable member that has no likelihood of hitting the user.

Control blocks of the robot 1 (particularly, the control section 10) may be realized by a logic circuit (hardware) provided in an integrated circuit (IC chip) or the like or may be realized by software as executed by a CPU (Central Processing Unit).

In the latter case, the robot 1 includes: a CPU that executes instructions of a program that is software realizing the foregoing functions; ROM (Read Only Memory) or a storage device (each referred to as “storage medium”) storing the program and various kinds of data in such a form that they are readable by a computer (or a CPU); and RAM (Random Access Memory) that develops the program in executable form. The object of the present invention can be achieved by a computer (or a CPU) reading and executing the program stored in the storage medium. The storage medium may be “a non-transitory tangible medium” such as a tape, a disk, a card, a semiconductor memory, and a programmable logic circuit. Further, the program may be made available to the computer via any transmission medium (such as a communication network and a broadcast wave) which enables transmission of the program. Note that the present invention can also be implemented by the program in the form of a computer data signal embedded in a carrier wave which is embodied by electronic transmission.

[Overview]

A robot in accordance with Aspect 1 of the present invention includes: a plurality of movable members; a detecting section configured to detect a location where the robot is being touched; and a control section configured to control the plurality of movable members such that, while the location is being detected, (i) out of the plurality of movable members, a movable member corresponding to the location is prohibited from moving and (ii) every other movable member of the plurality of movable members is permitted to move.

With the above configuration, in a case where the user touches the robot, a movable member corresponding to the detected location where the use is touching the robot is prohibited from moving. However, every other movable member is permitted to move. With this configuration, a movable member corresponding to a part of the robot touched by the user does not move, thereby preventing user injury. Furthermore, movement is permitted for each movable member other than a movable member corresponding to the part of the robot touched by the user. That is, movement is permitted for a movable member that has no likelihood of coming in contact with the user while moving. This enables the user to use the robot while touching the robot.

In this way, the robot in accordance with Aspect 1 enables injury-free use of the robot by the user while the user is touching the robot.

In Aspect 2 of the present invention, the robot of Aspect 1 is arranged such that in a case where the location is detected while at least one of the plurality of movable members is moving, the control section controls (i) a movable member, which corresponds to the location and is currently moving, to stop moving while the location is being detected and (ii) a movable member, which does not correspond to the location and is currently moving, to continue moving.

With the above configuration, in a case where the user touches the robot while any of the plurality of movable members is moving, a movable member corresponding to the detected location where the user is touching the robot will stop moving, but any other movable member that was moving will continue to move. This enables the user to continue using the robot injury-free even in a case where the user touches the robot while the robot is moving.

In Aspect 3 of the present invention, the robot of Aspect 1 or 2 is arranged such that: the robot further includes a receiving section configured to receive a movement commencement instruction intended for the robot, and in a case where (i) none of the plurality of movable members are currently being moved, (ii) the receiving section receives the movement commencement instruction, and (iii) the location is detected, the control section controls (a) a movable member, which corresponds to the location and is currently stopped, to continue stopping and (b) a movable member, which does not correspond to the location and is currently stopped, to commence moving.

With the above configuration, in a case where the robot receives a movement commencement instruction while the user is touching the robot and the robot is not moving, the robot will not commence any movement of a movable member being touched by the user, nor any movement of movable members in the vicinity thereof. This prevents the user from being injured by sudden commencement of movement any movable member.

In Aspect 4 of the present invention, the robot of any of Aspects 1 through 3 is arranged such that in a case where the location has ceased being detected, the control section controls a movable member, which corresponds to the location and is currently stopped, to commence moving.

With the above configuration, in a case where the user ceases to touch the robot, the robot can return to the state of normal movement it was in before being touched by the user. That is, the robot will not needlessly maintain a non-moving state of a movable member that has no likelihood of hitting the user.

A control method in accordance with Aspect 5 of the present invention is a method of controlling a robot which includes a plurality of movable members, the method including the steps of: (a) detecting a location where the robot is being touched; and (b) controlling the plurality of movable members such that (i) out of the plurality of movable members, a movable member corresponding to the location is prohibited from moving and (ii) every other movable member of the plurality of movable members is permitted to move.

The above method brings about advantageous effects similar to those of Aspect 1.

The aforementioned robot may be realized by a computer. In such a case, the present invention encompasses: a program which causes a computer to operate as the foregoing sections of the robot so that the robot can be realized by the computer; and a computer-readable storage medium storing the program therein.

The present invention is not limited to the embodiments, but can be altered by a skilled person in the art within the scope of the claims. An embodiment derived from a proper combination of technical means each disclosed in a different embodiment is also encompassed in the technical scope of the present invention. Further, it is possible to form a new technical feature by combining the technical means disclosed in the respective embodiments.

### INDUSTRIAL APPLICABILITY

The present invention has wide-ranging applications and can be utilized in any of a variety of robots that has a plurality of differing movable members.

### REFERENCE SIGNS LIST

1 Robot
10 Control section
11 Movement instruction receiving section (receiving section)
12 Touch detecting section (detecting section)
13 Touch status management section
14 Movement control section (control section)
15 Servo control section (control section)
20 Touch sensors
41 Head and neck part (movable member)
42 Right arm (movable member)
43 Left arm (movable member)
44 Pelvic part (movable member)
45 Right leg (movable member)
46 Left leg (movable member)

1. A robot comprising:
a plurality of movable members;
a detecting section configured to detect a location where the robot is being touched; and
a control section configured to control the plurality of movable members such that, while the location is being detected, (i) out of the plurality of movable members, a movable member corresponding to the location is prohibited from moving and (ii) every other movable member of the plurality of movable members is permitted to move.

2. The robot as set forth in claim 1, wherein
in a case where the location is detected while at least one of the plurality of movable members is moving, the control section controls (i) a movable member, which corresponds to the location and is currently moving, to stop moving while the location is being detected and (ii) a movable member, which does not correspond to the location and is currently moving, to continue moving.

3. The robot as set forth in claim 1, further comprising a receiving section configured to receive a movement commencement instruction, wherein
in a case where (i) none of the plurality of movable members are currently being moved, (ii) the receiving section receives the movement commencement instruction, and (iii) the location is detected, the control section controls (a) a movable member, which corresponds to the location and is currently stopped, to continue stopping and (b) a movable member, which does not correspond to the location and is currently stopped, to commence moving.

4. The robot as set forth in claim 1, wherein
in a case where the location has ceased being detected, the control section controls a movable member, which corresponds to the location and is currently stopped, to commence moving.

5. A method of controlling a robot which comprises a plurality of movable members, said method comprising the steps of:
(a) detecting a location where the robot is being touched; and
(b) controlling the plurality of movable members such that (i) out of the plurality of movable members, a movable member corresponding to the location is prohibited from moving and (ii) every other movable member of the plurality of movable members is permitted to move.

6. A non-transitory computer readable medium that stores a program that causes a computer to function as a robot recited in claim 1, the program causing the computer to function as each of the sections.
